(19) United States
(12) Patent Application Publication
(10) Pub. No.: US 2025/0283670 A1
(43) Pub. Date: Sep. 11, 2025

(54) MICRO-CELLULAR HEAT EXCHANGER WITH LOCAL FILTERING

(71) Applicant: FOUNDATION FOR RESEARCH AND BUSINESS, SEOUL NATIONAL UNIVERSITY OF SCIENCE AND TECHNOLOGY, Seoul (KR)

(72) Inventors: Keun PARK, Seoul (KR); Jun Won LEE, Seoul (KR); Seo Hyeon OH, Seoul (KR)

(21) Appl. No.: 18/286,389

(22) PCT Filed: Jan. 3, 2023
(86) PCT No.: PCT/KR2023/000077

§ 371 Date: May 20, 2025

(30) Foreign Application Priority Data
Sep. 19, 2022 (KR) 10-2022-0117960

(51) Int. Cl. F28F 7/02; F28D 9/00

(52) U.S. Cl. CPC F28F 7/02; F28D 9/0068; F28F 2210/02

(57) ABSTRACT

Disclosed herein is a microcellular structural heat exchanger with local filtering, which is capable of providing various functionalities by applying local filtering and adjusting a signed distance field of a TPMS so as to selectively control a flow of fluid to enhance thermo-fluidic efficiency in a TPMS microcellular structural heat exchanger.

### TECHNICAL FIELD

The present disclosure relates to a microcellular structural heat exchanger with local filtering so as to selectively control a flow of fluid.

### BACKGROUND ART

In general, a heat exchanger is a device for exchanging heat between two or more fluids, and examples of the heat exchanger include, depending on the shape thereof, a cylindrical multi-tube heat exchanger, a double tube heat exchanger, and a plate-type heat exchanger. Among them, the plate-type heat exchanger has a structure in which thin metal plates are stacked in a multi-layered manner, and performs heat exchange by passing hot/cold fluids between the multiple heat transfer plates that are cross-stacked. The plate-type heat exchanger can be used as a compact heat exchanger since it has high thermo-fluidic efficiency and a relatively small size.

However, the plate-type heat exchanger has a disadvantage in that its size increases as the number of stacked heat transfer plates must be increased to improve the heat exchange capacity of the heat exchanger. For example, plate-type heat exchangers (5 kW) are currently used for cooling electric vehicle batteries, but high-capacity heat exchangers (10 kW or more) for high-speed charging and long-distance traveling may increase in volume, resulting in space constraints.

In recent years, there has been proposed a triply periodic minimal surface (TPMS) heat exchanger using 3D printing technology. The TPMS heat exchanger uses a surface structure composed of three-dimensional combinations of sine/cosine functions. The TPMS heat exchanger can be effectively used to exchange heat between two types of fluids since it has a channel structure that uses a single surface to separate a three-dimensional space into two spaces. FIG. 1 illustrates a primitive (P) surface, a diamond (D) surface, and a gyroid (G) surface, which are representative TPMSs, and implicit functions for each may be expressed as follows:

$${φ}_{P} ( x , y , z ) = cos ( {ω}_{x} x ) + cos ( {ω}_{y} y ) + cos ( {ω}_{z} z )$$

$${φ}_{D} ( x , y , z ) = sin ( {ω}_{x} x ) sin ( {ω}_{y} y ) sin ( {ω}_{z} z ) + sin ( {ω}_{y} y ) cos ( {ω}_{y} y ) cos ( {ω}_{z} z ) + cos ( {ω}_{x} x ) sin ( {ω}_{y} y ) cos ( {ω}_{z} z ) + cos ( {ω}_{x} x ) cos ( {ω}_{y} y ) sin ( {ω}_{z} z )$$

$${φ}_{G} ( x , y , z ) = sin ( {ω}_{x} x ) cos ( {ω}_{y} y ) + sin ( {ω}_{y} y ) cos ( {ω}_{z} z ) + sin ( {ω}_{z} z ) cos ( {ω}_{x} x )$$

where ωₓ, ω_{y}, and ω_{z} denote angular frequencies in the x, y, and z directions, respectively, and are directly related to the size of the TPMS unit cell.

Cold/hot fluids may flow to these two separated spaces, enabling three-dimensional heat exchange, different from 2.5-dimensional heat exchange in conventional plate-type heat exchanger. In addition, the TPMS heat exchanger has a large surface area per unit volume and can be designed with a channel structure that is advantageous for the flow of fluid.

However, it may be difficult for the conventional TPMS heat exchanger to effectively control the flow of fluid due to the complex shape thereof. As an example, FIG. 2 illustrates a TPMS heat exchanger using the G surface of FIG. 1. The TPMS heat exchanger illustrated in FIG. 2 may generate high heat transfer efficiency when a fluid circulates in the vertical direction (longitudinal direction) of the body thereof. On the other hand, in the TPMS heat exchanger illustrated in FIG. 3, when a fluid circulates in the transverse direction (width direction) of the body thereof (for example, the inlet/outlet for hot fluid is located on the left side in the longitudinal direction, and the inlet/outlet for cold fluid is located on the right side in the longitudinal direction), the flows of hot and cold fluids may be concentrated only in a corresponding region without crossing each other. Accordingly, there is a problem in that the heat exchange efficiency may be decreased. In addition, when a fluid flows from the inlet/outlet region to the TPMS channel, a large pressure drop occurs due to a rapid change in cross-sectional area, which may lead to a decrease in heat exchange efficiency.

### DISCLOSURE

### Technical Problem

Various embodiments are directed to a microcellular structural heat exchanger with local filtering, which is capable of providing various functionalities by applying local filtering and adjusting a signed distance field of a TPMS so as to selectively control a flow of fluid to enhance thermo-fluidic efficiency in a TPMS microcellular structural heat exchanger.

### Technical Solution

In an embodiment, there is provided a heat exchanger that includes a triply periodic minimal surface (TPMS) structural body whose inside is separated into two flow channels using a TPMS composed of three-dimensional combinations of sine/cosine functions, the body being provided with an inlet and an outlet so that three-dimensional heat exchange is performed while a first hot fluid and a second cold fluid flow separately through the two flow channels, wherein the body is applied with local filtering by changing a signed distance field of the TMPS based on a transition function (F (x, y, z)) expressed by the following Equation:

$${φ}^{*} ( x , y , z ) = φ ( x , y , z ) + F ( x , y , z ) \qquad [ Equation ]$$

$$F ( x , y , z ) = {\sum }_{i = 1}^{n} \frac{{β}_{i}}{[ 1 + {e}^{- {k}_{x}^{i} ( x - {x}_{p}^{i} )} ] [ 1 + {e}^{- {k}_{y}^{i} ( y - {y}_{p}^{i} )} ] [ 1 + {e}^{- {k}_{z}^{i} ( z - {z}_{p}^{i} )} ]}$$

(where φ denotes a signed distance field function of the TPMS, φ* denotes a signed distance field function of the TPMS with mathematical filtering, kₓ denotes an x-direction transition coefficient, k_{y} denotes a y-direction transition coefficient, k_{z}denotes a z-direction transition coefficient, xₚ denotes an x-direction transition position, yₚ denotes a y-direction transition position, zₚ denotes a z-direction transition position, n denotes the number of superposed sigmoid functions, and βᵢ denotes a magnitude for each superposed sigmoid function).

The signed distance field function (φ) of the TPMS may use one of the following Equations that separately form various types of surfaces such as a primitive (P) surface, a diamond (D) surface, and a gyroid (G) surface (see FIG. 1):

$${φ}_{P} ( x , y , z ) = cos ( {ω}_{x} x ) + cos ( {ω}_{y} y ) + cos ( {ω}_{z} z )$$

$${φ}_{D} ( x , y , z ) = sin ( {ω}_{x} x ) sin ( {ω}_{y} y ) sin ( {ω}_{z} z ) + sin ( {ω}_{y} y ) cos ( {ω}_{y} y ) cos ( {ω}_{z} z ) + cos ( {ω}_{x} x ) sin ( {ω}_{y} y ) cos ( {ω}_{z} z ) + cos ( {ω}_{x} x ) cos ( {ω}_{y} y ) sin ( {ω}_{z} z )$$

$${φ}_{G} ( x , y , z ) = sin ( {ω}_{x} x ) cos ( {ω}_{y} y ) + sin ( {ω}_{y} y ) cos ( {ω}_{z} z ) + sin ( {ω}_{z} z ) cos ( {ω}_{x} x )$$

(where ωₓ, ω_{y}, and ω_{z} denote angular frequencies in x, y, and z directions, respectively, and are directly related to a size of a TPMS unit cell).

The inlet and the outlet may be provided with selection filters to block the other one of the two flow channels into which the first or second fluid is not introduced, so as to enable selective inflow of hot/cold fluid.

The flow channels may consist of a first flow channel through which the first fluid flows and having a first inlet and a first outlet, and a second flow channel through which the second fluid flows and having a second inlet and a second outlet.

The first inlet and the first outlet may be spaced transversely on one longitudinal side of the body, and the second inlet and the second outlet may be spaced transversely on the other longitudinal side of the body.

Barrier filters may be installed between the first inlet and the first outlet and between the second inlet and the second outlet, respectively, so as to control a flow of the same fluid to enlarge heat exchange areas of the first and second fluids.

One barrier filter installed between the first inlet and the first outlet may prevent flow of the first hot fluid, thereby enabling only the second cold fluid to pass through the second flow channel, and the other barrier filter installed between the second inlet and the second outlet may prevent flow of the second cold fluid, thereby enabling only the first hot fluid to pass through the first flow channel.

Each of the barrier filters may have a length of half or less of the total longitudinal length of the body.

The inlet and the outlet may be provided with boundary filters to increase regions of the flow channels by reducing a solid portion of the TPMS structure at boundaries of the inlet/outlet of the body in order to prevent an increase in pressure drop due to a reduction in width of each flow channel at the boundaries of the inlet/outlet.

Each of the boundary filters may be extended to a boundary region including an outer surface of the body having the inlet and the outlet.

### Advantageous Effects

The microcellular structural heat exchanger with local filtering according to the present disclosure having the above-mentioned configuration can selectively control the flow of fluid in the TPMS microcellular structural heat exchanger and enhance heat exchange performance by applying the filtering technique using the selection filters to enable inlet/outlet separation of hot/cold fluids and flow control through the selective barrier filters.

In addition, it is possible to reduce the pressure drop at the inlet/outlet by applying the boundary filters to the inlet/outlet region of the body to increase the flow regime of the inlet/outlet part. This allows the development of TPMS heat exchangers with improved flow characteristics and heat exchange capability.

### BRIEF DESCRIPTION OF DRAWINGS

FIG. 1 is a view illustrating various conventional TPMS shapes.

FIG. 2 is a top view illustrating a state of heat exchange through a longitudinal flow of a conventional TPMS heat exchanger.

FIG. 3 is a top view showing a state of heat exchange through a transverse flow of a conventional TPMS heat exchanger.

FIGS. 4 (a) and 4 (b) are views illustrating a signed distance field of a TPMS structure according to the present disclosure.

FIGS. 5A to 5C are graphs illustrating sigmoid transition functions according to the present disclosure.

FIG. 6 is a perspective view illustrating a microcellular structural heat exchanger with local filtering according to the present disclosure.

FIG. 7 is a perspective view illustrating a TPMS structural body applied to the heat exchanger of FIG. 6.

FIG. 8 is a perspective view illustrating a state in which selection filters are applied to the heat exchanger according to the present disclosure.

FIG. 9 is a top view illustrating regions of hot/cold fluids applied to the TPMS structural body.

FIG. 10 is a view illustrating the signed distance field of FIG. 9.

FIG. 11 is a top view illustrating a state in which the selection filters are applied in the present disclosure.

FIG. 12 illustrates design parameters for the application of the selection filters according to the present disclosure.

FIG. 13 is a view illustrating a signed distance field obtained by applying the selection filters according to the present disclosure.

FIG. 14 is a view illustrating flow channels selectively formed in hot/cold regions by the selection filters according to the present disclosure.

FIG. 15 is a top view illustrating a state in which barrier filters are applied in the present disclosure.

FIG. 16 illustrates design parameters for the application of the barrier filters according to the present disclosure.

FIG. 17 illustrates a signed distance field when the barrier filters are applied in the present disclosure.

FIG. 18 is a top view illustrating hot/cold flow channels when the barrier filters are applied in the present disclosure.

FIG. 19 is a perspective view illustrating a state in which boundary filters are applied to four upper corners of the body according to the present disclosure.

FIG. 20 is a top view of FIG. 19.

FIG. 21 is a view illustrating a flow regime of hot/cold fluids when boundary filters are applied in the present disclosure.

FIGS. 22 and 23 illustrate a state in which boundary filters are extended to a boundary region including an inlet/outlet and outer surface of a body in another embodiment of the present disclosure.

FIGS. 24 and 25 are top views of FIG. 22.

FIG. 26 is a view illustrating a flow regime of hot/cold fluids when boundary filters are applied in another embodiment of the present disclosure.

FIG. 27 is an example of a heat exchanger in which inlets and outlets of a body are arranged in transversely the present disclosure.

FIG. 28 is a graph illustrating a trend of pressure drop at the inlet/outlet under the application of the boundary filters according to the present disclosure.

### LIST OF REFERENCE NUMERALS

100: heat exchanger
W1: first fluid
W2: second fluid
110: body
111: first flow channel
111a: first inlet
111b: first outlet
112: second flow channel
112a: second inlet
112b: second outlet
115: selection filter
120: barrier filter
130: boundary filter
H: through-hole

### Mode for Disclosure

Hereinafter, the configuration and operation of the specific embodiments of the present disclosure will be described in detail with reference to the accompanying drawings.

It should be noted that reference numerals are added to the components of the accompanying drawings to facilitate understanding of the embodiments described below and the same reference numbers will be marked throughout the drawings to refer to the same or like parts wherever possible.

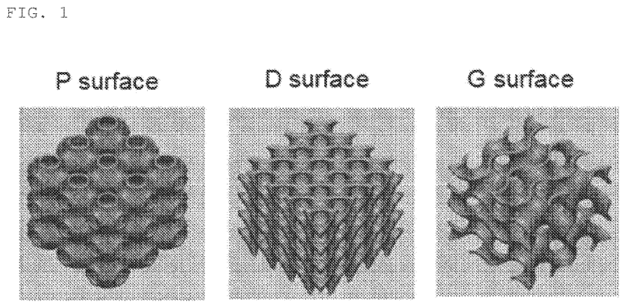

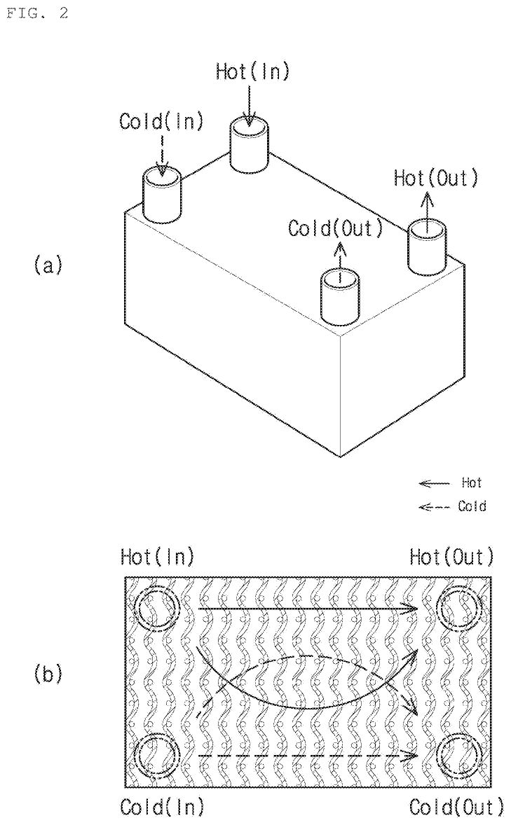

First, a gyroid surface (G-surface, see FIG. 1) of TPMSs for forming a body 110 of the present disclosure may be basically expressed by the following Equation (1):

$${φ}_{G} ( x ) = sin ( {ω}_{x} x ) cos ( {ω}_{y} y ) + sin ( {ω}_{y} y ) cos ( {ω}_{z} z ) + sin ( {ω}_{z} z ) cos ( {ω}_{x} x ) \qquad ( 1 )$$

where ωₓ, ω_{y}, and ω_{z} denote angular frequencies in the x, y, and z directions, respectively, and are directly related to the size of the TPMS unit cell.

The shell structure based on the TPMS is expressed in a level-set form as shown in the following Equation (2):

$$φ ( x ) : \{ \begin{matrix}φ ( x ) > C , & ∀ x ∈ {Ω}_{1} & ( Positive void ) \\ \vert φ ( x ) \vert < C , & ∀ x ∈ {Ω}_{2} & ( Solid wall ) \\ φ ( x ) < - C , & ∀ x ∈ {Ω}_{3} & ( Negative void )\end{matrix} \qquad ( 2 )$$

where C is a level-set constant that determines the wall thickness of a TPMS structure, and the domain Ω₂ corresponds to a shell structure with a thickness.

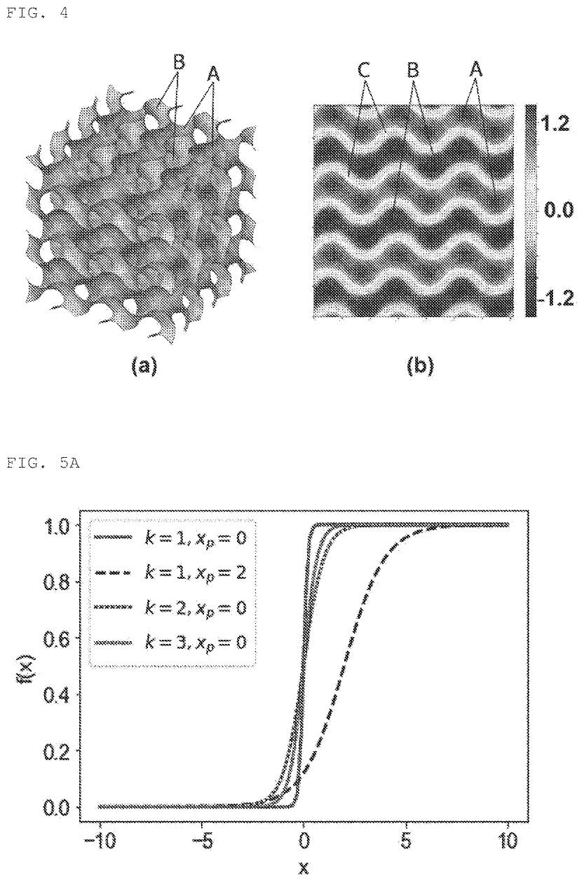

The domains Ω₁ and Ω₃ correspond to the inner side (red (A) region in FIG. 4 (a)) and the outer side (blue (B) region in FIG. 4 (a)) of a wall, and are expressed as shown in FIG. 4 (b) if they are expressed as signed distance fields in cross-section. That is, in FIG. 4 (b), the portion represented by red (A) is defined as a positive (+) distance field, and the portion represented by blue (B) is defined as a negative (−) distance field, which are distinguished by the wall (C). Accordingly, for application to a heat exchanger, heat exchange through the wall may be performed by utilizing the positive distance field region as a hot fluid channel and the negative distance field region as a cold fluid channel. For reference, an example is described herein in which the positive distance field region is utilized as a hot fluid channel and the negative distance field region is utilized as a cold fluid channel, but the present disclosure is not limited thereto. For example, the positive distance field region may be utilized as a cold fluid channel and the negative distance field region may be utilized as a hot fluid channel.

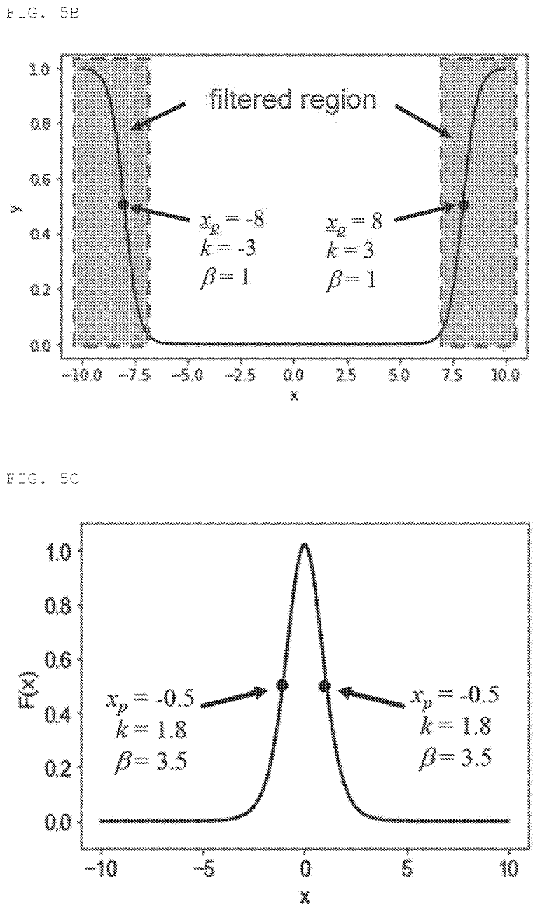

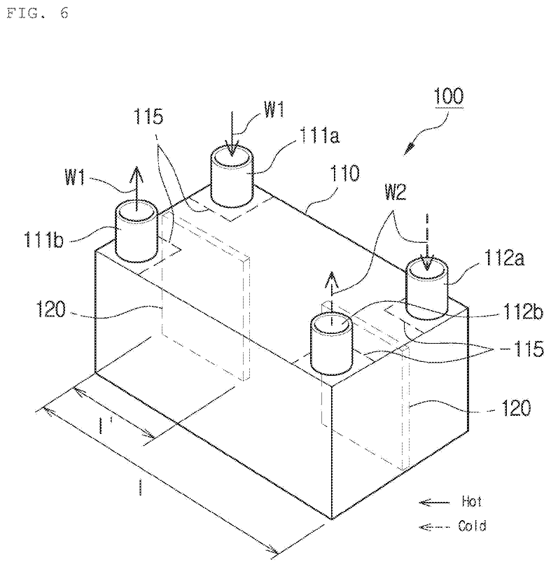

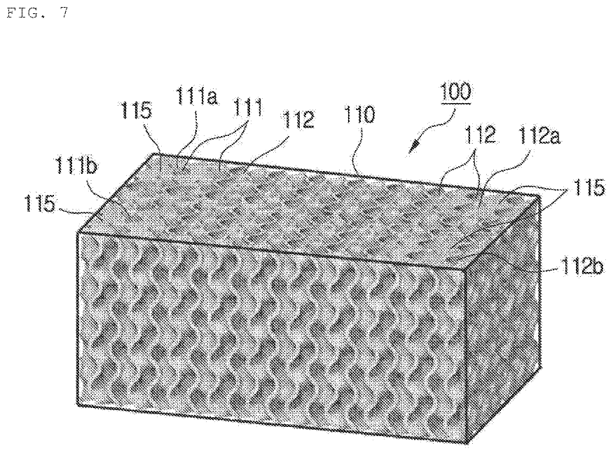

In this case, various functionalities should be provided in order to use the body 110 of the TPMS structure as a heat exchanger. The present disclosure introduces a filtering technique for modifying a TPMS signed distance field using a transition function in the form of a sigmoid function. The sigmoid function is defined as the following Equation (3), and is a function that changes between 0 and 1 as shown in FIG. 5A:

$$f ( x ) = \frac{1}{1 + {e}^{- k ( x - {x}_{p} )}} \qquad ( 3 )$$

where k is a transition coefficient that affects the slope of the transition interval, and xₚ determines a transition position and adjusts a corresponding factor to provide various types of local changes to the signed distance field of the TPMS.

The transition function may be extended to a complex function obtained by superposing multiple sigmoid functions as shown in the following Equation (4), which corresponds to a Boolean addition (OR) operation. FIG. 5B illustrates a complex transition function obtained by superposing two sigmoid functions (n=2), which performs filtering by locally increasing the signed distance field at both ends of the interval.

$$F ( x ) = {\sum }_{i = 1}^{n} \frac{{β}_{i}}{1 + {e}^{- {k}_{x}^{i} ( x - {x}_{p}^{i} )}} \qquad ( 4 )$$

where βᵢ denotes a magnitude for each superposed sigmoid function, and the weight for each transition function may be adjusted.

The transition function may be extended through the product of multiple sigmoid functions as shown in the following Equation (5), which corresponds to a Boolean multiplication (AND) operation. FIG. 5C illustrates shows a complex transition function obtained by multiplying two sigmoid functions, which locally increases a specific region by multiplying two functions with opposite slopes (−1.8, 1.8) at two different transition positions (−0.5, 0.5).

$$F ( x ) = {\prod }_{i = 1}^{n} \frac{{β}_{i}}{1 + {e}^{- {k}_{x}^{i} ( x - {x}_{p}^{i} )}} \qquad ( 5 )$$

The superposition of the transition functions is extended to a three-dimensional space to generalize superposition of n transition functions, as expressed by the following Equation (6):

$$F ( x , y , z ) = {\sum }_{i = 1}^{n} \frac{{β}_{i}}{[ 1 + {e}^{- {k}_{x}^{i} ( x - {x}_{p}^{i} )} ] [ 1 + {e}^{- {k}_{y}^{i} ( y - {y}_{p}^{i} )} ] [ 1 + {e}^{- {k}_{z}^{i} ( z - {z}_{p}^{i} )} ]} \qquad ( 6 )$$

where kₓ denotes an x-direction transition coefficient, k_{y}denotes a y-direction transition coefficient, k_{z} denotes a z-direction transition coefficient, xₚ denotes an x-direction transition position, yₚ denotes a y-direction transition position, zₚ denotes a z-direction transition position, n denotes the number of superposed sigmoid functions, and βᵢ denotes a magnitude for each superposed sigmoid function.

When the above Equation (6) is added to the TPMS function of Equation (1), the TPMS function to which filtering is applied is expressed by the following equation (7). Based on the above formulation, various types of filtering may be performed by changing the combinations of transition coefficients, transition positions, and magnification coefficients.

$${φ}_{G}^{*} ( x , y , z ) = {φ}_{G} ( x , y , z ) + F ( x , y , z ) \qquad ( 7 )$$

Hereinafter, a heat exchanger 100 according to the present disclosure formed using the above formulas will be described in detail.

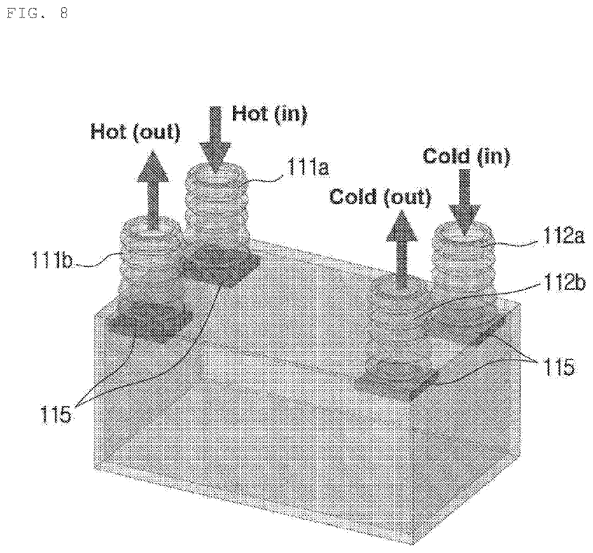

FIG. 6 is a perspective view illustrating a microcellular structural heat exchanger with local filtering according to the present disclosure. FIG. 7 is a perspective view illustrating a TPMS structural body applied to the heat exchanger of FIG. 6.

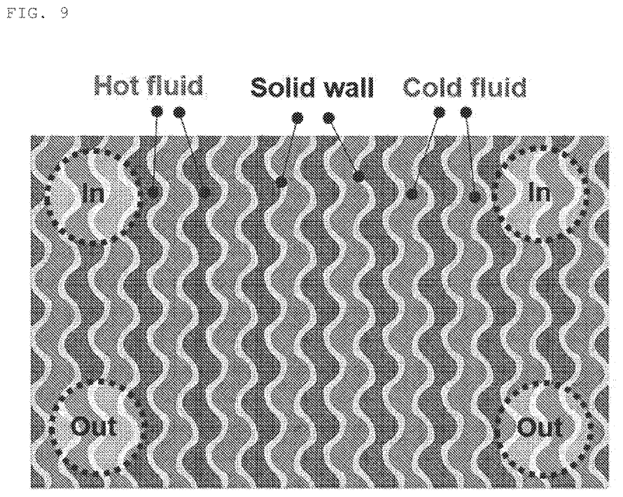

Referring to FIGS. 6 and 7, the microcellular structural heat exchanger 100 according to the preferred embodiment of the present disclosure may include a body 110 whose inside is separated into two flow channels 111 and 112 using a TPMS composed of three-dimensional combinations of sine/cosine functions. The flow channels 111 and 112 may be formed by twisting each other in all directions of the body 110, and may each have a plurality of through-holes H (see FIG. 8) formed therein to enable the flow of fluid in the same space.

In addition, the body 110 may be provided with inlets 111a and 112a and outlets 111b and 112b spaced apart from each other so that three-dimensional heat exchange may be performed while a first hot fluid W1 and a second cold fluid W2 flow separately through the two flow channels 111 and 112.

Specifically, the flow channels may consist of a first flow channel 111 provided with a first inlet 111a and a first outlet 111b through which the first fluid W1 flows, and a second flow channel 112 provided with a second inlet 112a and a second outlet 112b through which the second fluid W2 flows. The first inlet 111a and the first outlet 111b may be spaced transversely on one longitudinal side of the body 110, and the second inlet 112a and the second outlet 112b may be spaced transversely on the other longitudinal side of the body 110.

Referring to FIG. 8, the inlets 111a and 112a and the outlets 111b and 112b may be provided with selection filters 115 so as to enable selective introduction of the first fluid W1 and the second fluid W2 through the two flow channels 111 and 112. The selection filters 115 may perform closure by substituting flow channel inlets of other fluid regions with solid regions in corresponding regions of the inlets 111a and 112a and the outlets 111b and 112b.

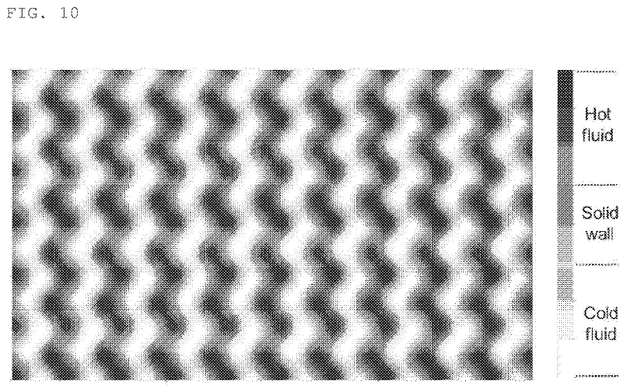

That is, the inlet/outlet for hot/cold fluid must be clearly distinguished in order to use the body 110 as the heat exchanger 100. However, as illustrated in FIG. 9, the inlets 111a and 112a and the outlets 111b and 112b have hot/cold fluid regions (red: hot channel, and blue: cold channel) mixed with each other, which may make it difficult to selectively introduce the fluid. This can usually be solved by blocking other fluid regions in the corresponding regions, but requires manual work using 3D CAD software or the like for modification of design. For reference, FIG. 10 illustrates a signed distance field when the selection filters 115 are not applied.

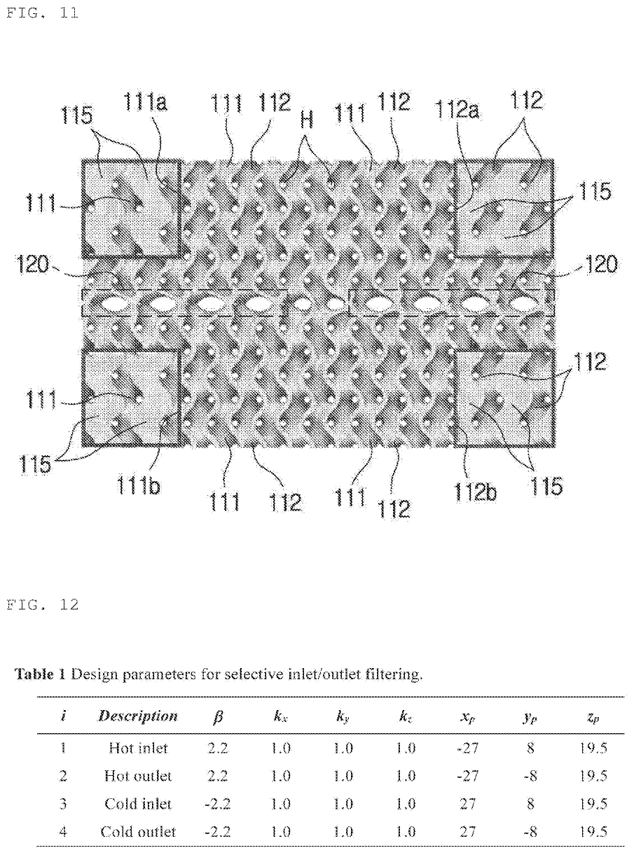

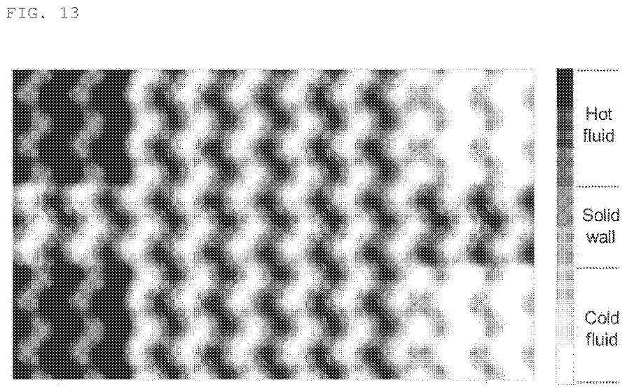

Accordingly, as illustrated in FIG. 11, the fluid may pass through only the corresponding flow channel of the two flow channels 111 and 112, and the other flow channel may be blocked by the filters 115. In this case, each of the filtering regions through the selection filters 115 was defined as a region with a size of 22×22×2.5 mm, for example, in each of the four upper corners of the body 110 (n=4). Four transition functions were superposed and applied to the corresponding regions using Equation (5), and the main factors of each transition function were summarized in Table 1 of FIG. 12.

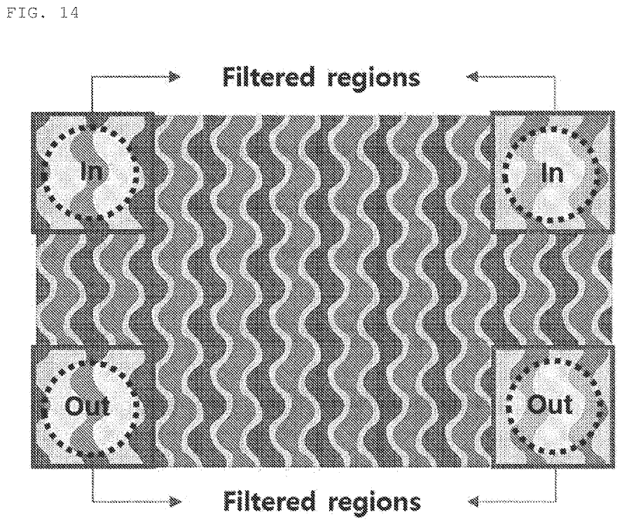

FIG. 13 illustrates the signed distance field obtained by applying the selection filters 115 as the corresponding transition functions. In the two left hot inlet/outlet regions, the overall signed distance field increased, resulting in the loss of all cold fluid regions. Similarly, in the two right hot inlet/outlet regions, the overall signed distance field decreased, resulting in the loss of all hot fluid regions.

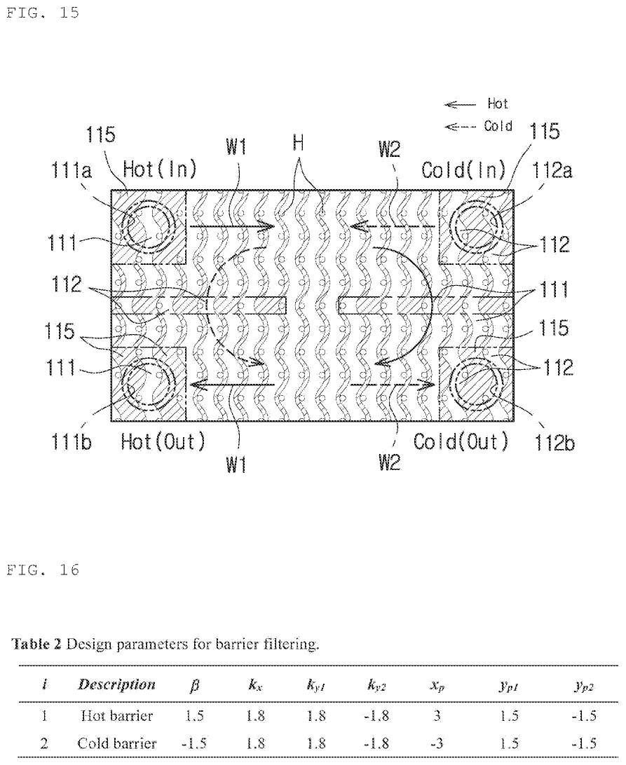

In addition, as illustrated in FIG. 14, it can be seen that the flow channels are formed such that only the hot fluid may pass through the left hot region of the body 110 and only the cold fluid may pass through the right cold region.

Referring back to FIG. 6, barrier filters 120 may be installed between the first inlet 111a and the first outlet 111b and between the second inlet 112a and the second outlet 112b, respectively, so as to effectively control the direction of flow inside the TPMS. The barrier filters 120 may be applied to the heat exchanger 100 where the transverse flow of fluid is unavoidable due to the structure of the device to be applied, in order to block the flow of the same fluid. The barrier filters 120 may allow the heat exchange areas of the first fluid W1 and the second fluid W2 to be enlarged, thereby enhancing the heat transfer efficiency of the heat exchanger 100.

Specifically, referring to FIG. 15, the barrier filter 120 installed between the first inlet 111a and the first outlet 111b prevents flow of the first hot fluid W1, thereby enabling only the second cold fluid W2 to pass through the second flow channel 112. The barrier filter 120 installed between the second inlet 112a and the second outlet 112b prevents flow of the second cold fluid W2, thereby enabling only the first hot fluid W1 to pass through the first flow channel 111.

Preferably, the above barrier filters 120 may have the same height as the inside of the TPMS structural body 110. In addition, the length (l′) of each barrier filter 120 may be formed to ½ or less of the total longitudinal length (l) of the body 110 (see FIG. 6).

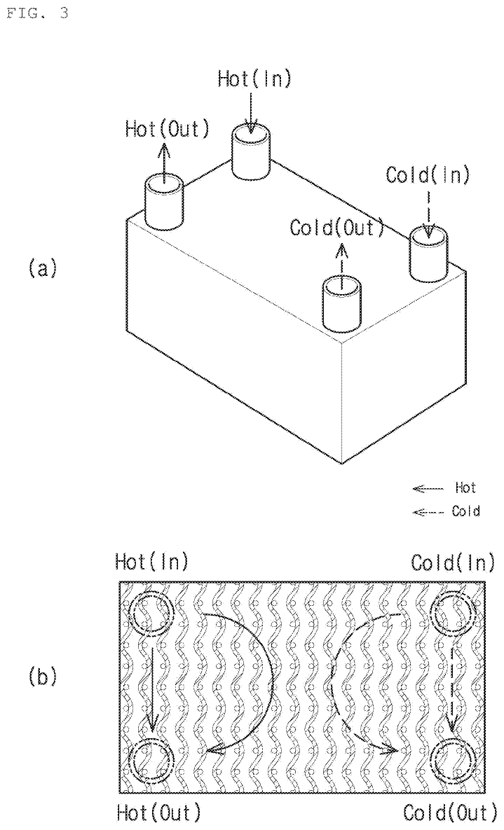

That is, when the length (l′) of the barrier filter 120 is more than half of the total longitudinal (l) of the body 110, the transverse flow of the first fluid W1 or the second fluid W2 may not be smooth in the middle region of the body 110. Accordingly, heat exchange within the body 110 cannot be performed properly. Conversely, when the length of the barrier filter 120 is too short than half of the total longitudinal length of the body 110, similar to the conventional heat exchanger, there is a concern that the flows of hot/cold fluids may be concentrated only in a corresponding region without crossing each other (see FIG. 3 (b)). Therefore, it is preferable that the length (l′) of the barrier filter 120 be formed to half or less of the total longitudinal length (l) of the body 110, but not too short, so as to enable the smooth flow and intersection of hot/cold fluids over the entire region of the body 110.

The filtering function for forming the pair of barrier filters 120 may be expressed by the following Equation (8):

$$F ( x , y ) = {\sum }_{i = 1}^{2} \frac{{β}_{i}}{[ 1 + {e}^{- {k}_{x}^{i} ( x - {x}_{p}^{i} )} ] [ 1 + {e}^{- {k}_{y 1}^{i} ( y - {y}_{p 1}^{i} )} ] [ 1 + {e}^{- {k}_{y 2}^{i} ( y - {y}_{p 2}^{i} )} ]} \qquad ( 8 )$$

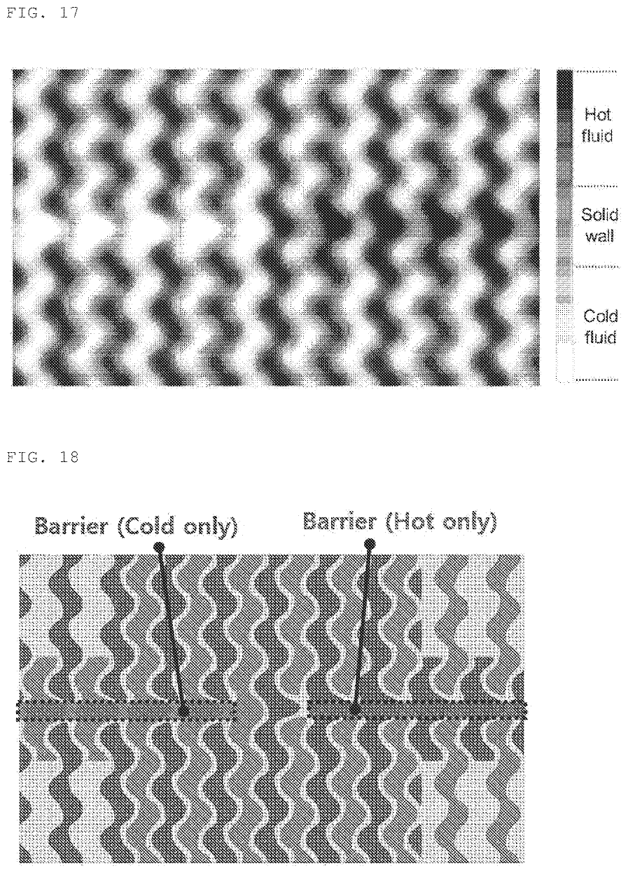

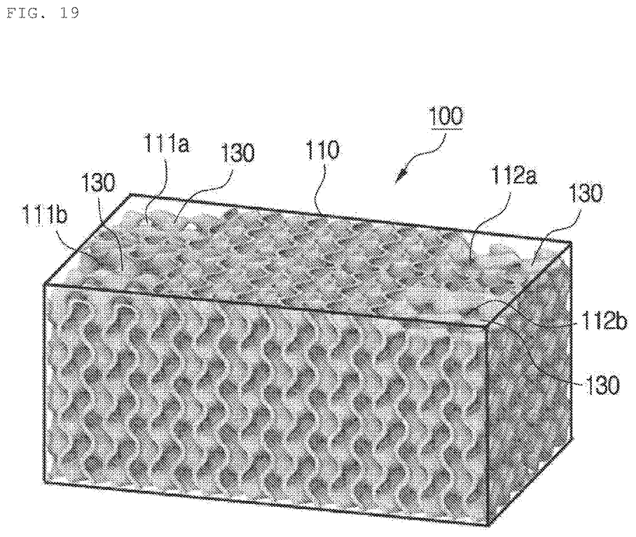

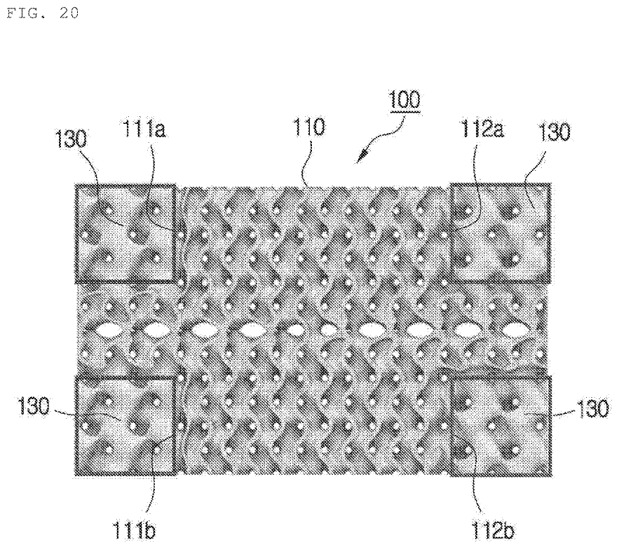

In this case, the pair of barrier filters 120 are designed as illustrated in Table 2 of FIG. 16, and the signed distance when the barrier filters 120 are applied is shown in FIG. 17. It can be seen from the applied signed distance field that the positive signed distance field corresponding to the hot flow channel does not exist in the cold filter region, and similarly, the negative signed distance field corresponding to the cold flow channel does not exist in the hot filter region. FIG. 18 illustrates hot/cold flow channels when the barrier filters 120 are applied. In FIG. 18, it can be seen that a selective flow channel may be formed through the two barrier filters 120.

Meanwhile, the pressure drop of the fluid may increase as the selection filters 115 (see FIG. 17) are applied to the regions of the inlets 111a and 112a and the outlets 111b and 112b. That is, the selection filters 115 may allow for the selective inflow of hot/cold fluid, but may decrease the width of the flow channel, thereby increasing the pressure drop of the fluid introduced through the inlets 111a and 112a and the outlets 111b and 112b.

In order to prevent this increase in pressure drop, as illustrated in FIGS. 19 and 20, boundary filters 130 may be applied in the regions of the inlets 111a and 112a and outlets 111b and 112b of the body 110. The boundary filters 130 may increase the regions of the flow channels 111 and 112 by reducing the solid portion of the TPMS structure at the boundary of the inlet/outlet regions of the body 110.

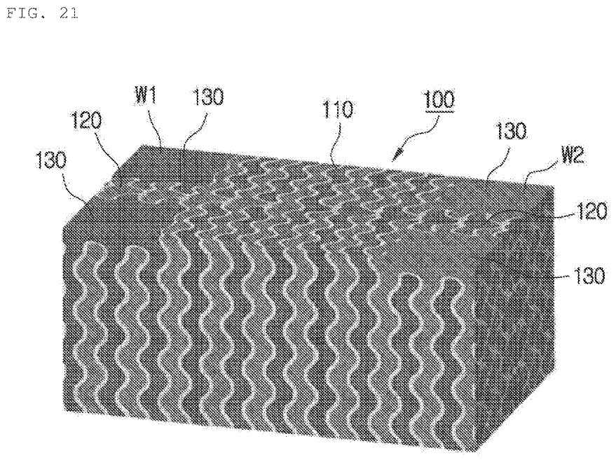

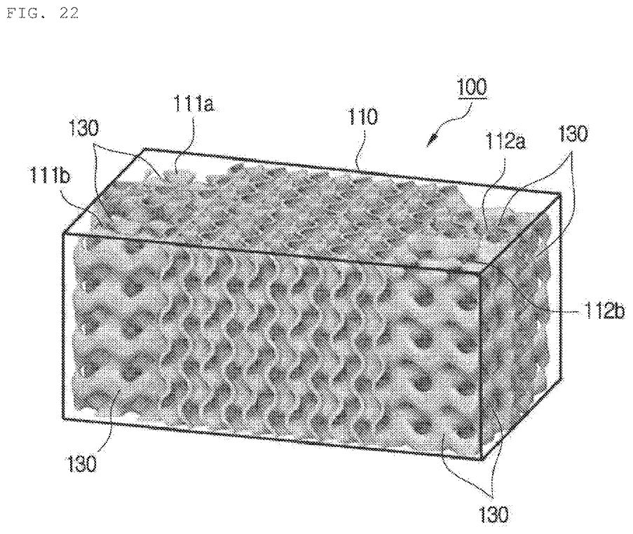

FIG. 21 is a view illustrating the flow region of hot/cold fluid under the application of the boundary filters 130. In FIG. 21, it can be seen that the flow region in the body 110 is increased as the boundary filters 130 are applied to the regions of the inlets 111a and 112a and the outlets 111b and 112b.

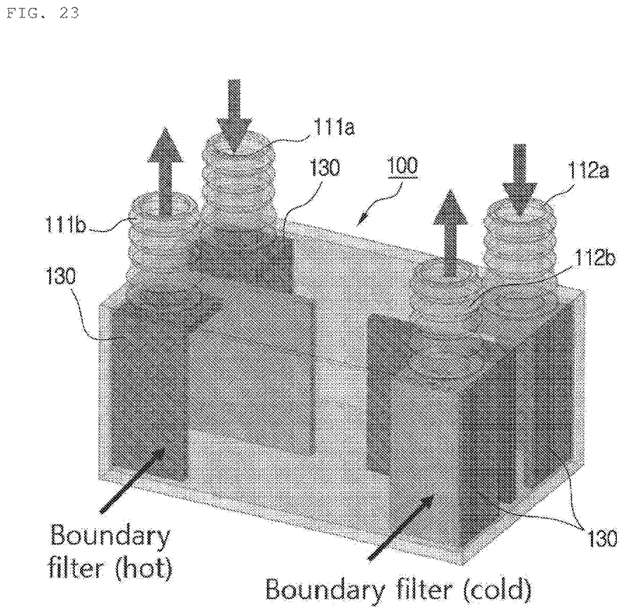

FIG. 22 illustrates another embodiment in which boundary filters 130 are extended to boundary regions including an outer surface of a body 110 having inlets 111a and 112a and outlets 111b and 112b so as to further reduce the pressure drop at the inlets 111a and 112a and the outlets 111b and 112b. As a result, as the solid region is further reduced, the flow characteristics of the heat exchanger 100 can be enhanced (the pressure drop is reduced).

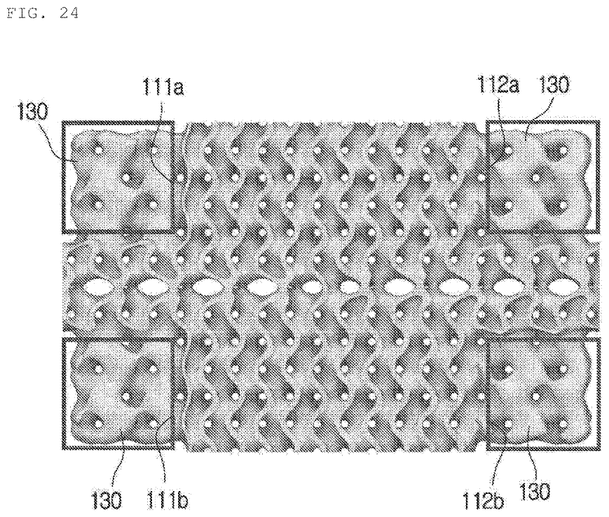

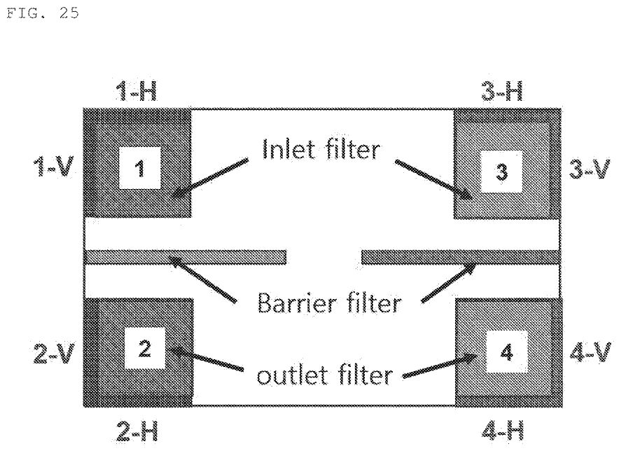

More specifically, referring to FIGS. 23 and 24, a large pressure drop may occur at the inlets/outlets 111a, 111b, 112a, and 112b of the heat exchanger 100 due to a rapid change in cross-section of the flow channel. The boundary filters 130 have been designed to reduce the pressure drop at the inlet/outlet. Each of the boundary filters 130 is designed to extend to the lower end of the TPMS body 110 while maintaining a constant thickness in the direction perpendicular to the filtering region (regions 1 to 4 in FIG. 25) for flow selection of the upper part of the inlet/outlet.

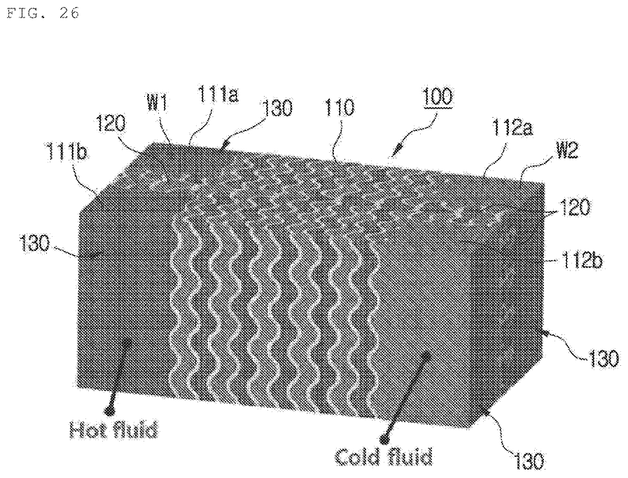

Referring to FIG. 25, the boundary filters 130 are formed for a total of eight regions marked with horizontal boundaries 1-H, 2-H, 3-H, and 4-H and vertical boundaries 1-V, 2-V, 3-V, and 4-V. To apply the boundary filters 130, a positive signed distance field was applied to the hot fluid inlet/outlet regions 1-H, 1-V, 2-H, and 2-V to increase the solid portion of the flow regime of the fluid as a whole and thus reduce the flow resistance. Similarly, a negative signed distance field was applied to the cold fluid inlet/outlet regions 3-H, 3-V, 4-H, and 4-V to increase the flow regime of the fluid as a whole and thus reduce the flow resistance. In FIG. 26, when the boundary filters 130 are applied, the hot/cold flow channels are shown in color. It is expected that the flow resistance may be reduced as the hot/cold fluid is introduced throughout the boundary region.

The microcellular structural heat exchanger with local filtering 100 according to the present disclosure having the above-mentioned configuration can selectively control the flow of fluid in the TPMS microcellular structural heat exchanger to enhance thermo-fluidic efficiency.

In addition, the heat exchanger 100 can be designed compactly while increasing the heat transfer area, so as to be applied to a heat exchanger for cooling an electric vehicle battery that requires slimming/lightening.

In particular, the heat exchanger 100 applies the filtering technique using the selection filters 115 to enable inlet/outlet separation of hot/cold fluids and flow control through the selective barrier filters 120, thereby enhancing heat exchange performance.

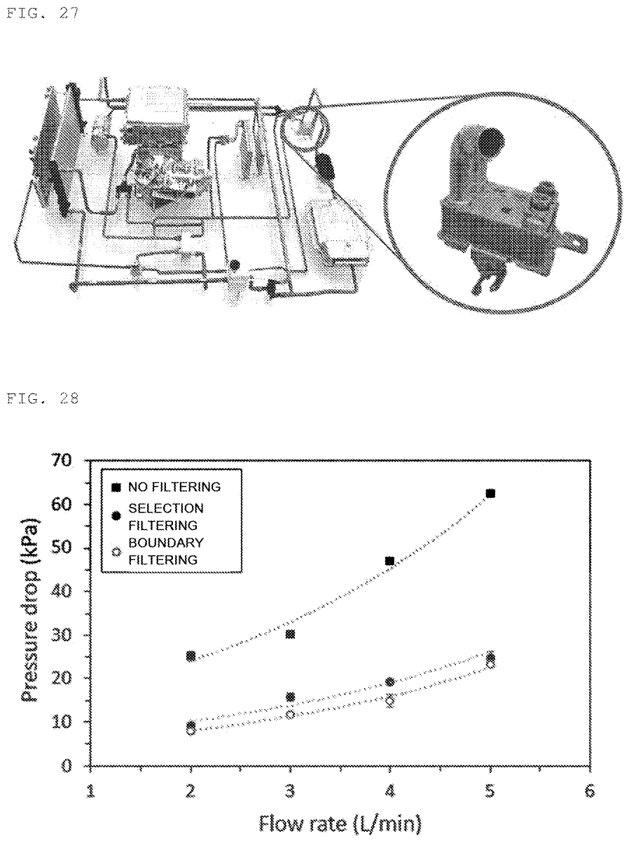

In addition, as illustrated in FIG. 27, efficient heat exchange can be realized in the structure of the heat exchanger in which the inlets and outlets are arranged in the transverse direction of the body 110.

In addition, as illustrated in FIG. 28, it is possible to reduce the pressure drop at the inlet/outlet by applying the boundary filters 130 to the inlet/outlet region of the body 110 to increase the flow regime of the inlet/outlet part (when the boundary filters of FIG. 22 are applied, the pressure drop is reduced by ⅓). This allows the development of TPMS heat exchangers with improved flow characteristics and heat exchange capability.

Although the present disclosure has been described with respect to the specific embodiments, it will be apparent to those skilled in the art that the present disclosure is not limited to the above-described embodiments and various changes and modifications are possible without departing from the technical spirit of the invention.

1. A heat exchanger comprising:
a triply periodic minimal surface (TPMS) structural body whose inside is separated into two flow channels using a TPMS composed of three-dimensional combinations of sine/cosine functions, the body being provided with an inlet and an outlet so that three-dimensional heat exchange is performed while a first hot fluid and a second cold fluid flow separately through the two flow channels,
wherein the body is applied with local filtering by changing a signed distance field of the TMPS based on a transition function (F (x, y, z)) expressed by the following Equation:
$${φ}^{*} ( x , y , z ) = φ ( x , y , z ) + F ( x , y , z ) \qquad [ Equation ]$$
$$F ( x , y , z ) = {\sum }_{i = 1}^{n} \frac{{β}_{i}}{[ 1 + {e}^{- {k}_{x}^{i} ( x - {x}_{p}^{i} )} ] [ 1 + {e}^{- {k}_{y}^{i} ( y - {y}_{p}^{i} )} ] [ 1 + {e}^{- {k}_{z}^{i} ( z - {z}_{p}^{i} )} ]}$$
(where φ denotes a signed distance field function of the TPMS, φ* denotes a signed distance field function of the TPMS with mathematical filtering, kₓ denotes an x-direction transition coefficient, k_{y} denotes a y-direction transition coefficient, k_{z} denotes a z-direction transition coefficient, xₚ denotes an x-direction transition position, yₚ denotes a y-direction transition position, zₚ denotes a z-direction transition position, n denotes the number of superposed sigmoid functions, and βᵢ denotes a magnitude for each superposed sigmoid function).

2. The heat exchanger according to claim 1, wherein the signed distance field function (φ) of the TPMS uses one of the following Equations that separately form various types of surfaces such as a primitive (P) surface, a diamond (D) surface, and a gyroid (G) surface (see FIG. 1):
$${φ}_{P} ( x , y , z ) = cos ( {ω}_{x} x ) + cos ( {ω}_{y} y ) + cos ( {ω}_{z} z )$$
$${φ}_{D} ( x , y , z ) = sin ( {ω}_{x} x ) sin ( {ω}_{y} y ) sin ( {ω}_{z} z ) + sin ( {ω}_{y} y ) cos ( {ω}_{y} y ) cos ( {ω}_{z} z ) + cos ( {ω}_{x} x ) sin ( {ω}_{y} y ) cos ( {ω}_{z} z ) + cos ( {ω}_{x} x ) cos ( {ω}_{y} y ) sin ( {ω}_{z} z )$$
$${φ}_{G} ( x , y , z ) = sin ( {ω}_{x} x ) cos ( {ω}_{y} y ) + sin ( {ω}_{y} y ) cos ( {ω}_{z} z ) + sin ( {ω}_{z} z ) cos ( {ω}_{x} x )$$
(where ωₓ, ω_{y}, and ω_{z} denote angular frequencies in x, y, and z directions, respectively, and are directly related to a size of a TPMS unit cell).

3. The heat exchanger according to claim 1, wherein the inlet and the outlet are provided with selection filters to block the other one of the two flow channels into which the first or second fluid is not introduced, so as to enable selective inflow of hot/cold fluid.

4. The heat exchanger according to claim 1, wherein the flow channels consist of:
a first flow channel through which the first fluid flows and having a first inlet and a first outlet; and
a second flow channel through which the second fluid flows and having a second inlet and a second outlet.

5. The heat exchanger according to claim 4, wherein:
the first inlet and the first outlet are spaced transversely on one longitudinal side of the body; and
the second inlet and the second outlet are spaced transversely on the other longitudinal side of the body.

6. The heat exchanger according to claim 4, wherein barrier filters are installed between the first inlet and the first outlet and between the second inlet and the second outlet, respectively, so as to control a flow of the same fluid to enlarge heat exchange areas of the first and second fluids.

7. The heat exchanger according to claim 6, wherein:
one barrier filter installed between the first inlet and the first outlet prevents flow of the first hot fluid, thereby enabling only the second cold fluid to pass through the second flow channel; and
the other barrier filter installed between the second inlet and the second outlet prevents flow of the second cold fluid, thereby enabling only the first hot fluid to pass through the first flow channel.

8. The heat exchanger according to claim 6, wherein each of the barrier filters has a length of half or less of the total longitudinal length of the body.

9. The heat exchanger according to claim 1, wherein the inlet and the outlet are provided with boundary filters to increase regions of the flow channels by reducing a solid portion of the TPMS structure at boundaries of the inlet/outlet of the body in order to prevent an increase in pressure drop due to a reduction in width of each flow channel at the boundaries of the inlet/outlet.

10. The heat exchanger according to claim 9, wherein each of the boundary filters is extended to a boundary region comprising an outer surface of the body having the inlet and the outlet.
